(19) United States
(12) Patent Application Publication
(10) Pub. No.: US 2006/0290256 A1
(43) Pub. Date: Dec. 28, 2006

(54) Panel

(75) Inventors: Junichi Seki, Tokyo (JP); Yukihiro Azuma, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/342,660

(22) Filed: Jan. 31, 2006

(30) Foreign Application Priority Data
Jan. 31, 2005 (JP) P2005-024533

(51) Int. Cl. H01J 29/10

(52) U.S. Cl. 313/463

(57) ABSTRACT

A panel comprises a substrate; a sealing plate opposing the substrate; a light-emitting device provided on a face opposing the sealing plate in the substrate; a plurality of spacers provided between the substrate and sealing plate so as to be in contact therewith and arranged about the light-emitting device; and a sealant layer, arranged between the substrate and sealing plate so as to bond the substrate and seating plate to each other, including the light-emitting device and spacers therewithin.

### BACKGROUND OF THE INVENTION

1. Field of the Invention

The present invention relates to a panel, e.g., a panel for mounting an EL device or the like.

2. Related Background Art

Light-emitting devices such as EL (Electro Luminescence) devices are characteristically easy to reduce their size and weight, and thus are expected to be applied to displays, illumination, and the like. One of important factors required for these light-emitting devices to be practically used for the purposes mentioned above is long life. Therefore, it has conventionally been typical for these light-emitting devices to be used in the form of a panel in which a structure constituting such a device is sealed between a substrate and a sealing plate in order to suppress external influences as much as possible and attain a longer life.

Recently, the gap between the substrate and the sealing plate in thus constructed panel has been filled with a sealant such as resin in order for the light-emitting device to attain a farther longer life. Such filling with the sealant further restrains the light-emitting device from coming into contact with the outside air, which makes it much harder for the light-emitting device to deteriorate and so forth. Since the light-emitting device is thus covered with the sealant, external forces are less influential to the light-emitting device, whereby the light-emitting device can be kept from being broken by external forces exerted thereon.

Known as an example of panels in which the gap between a substrate and a sealing plate is thus filled with a sealant is a light-emitting apparatus comprising a first sealant arranged so as to surround a light-emitting device on the substrate, and a second sealant provided so as to cover a pixel part (light-emitting device) on the inside of the first sealant (see Japanese Patent Application Laid-Open No. 2004-39542).

### SUMMARY OF THE INVENTION

The inventors studied the panel disclosed in the above-mentioned publication and, as a result, have found the following problem. Namely, when used for a long period, the panel disclosed in the above-mentioned publication tends to exhibit a nonluminous region (dark spot) in the light-emitting device, thereby gradually decreasing the light-emitting area. Therefore, the above-mentioned panel requires further improvement from the viewpoint of longer life.

In view of such circumstances, it is an object of the present invention to provide a panel which can prevent the light-emitting area from decreasing even when used for a long period.

For achieving the above-mentioned object, in one aspect, the present invention provides a panel comprising a substrate; a sealing plate opposing the substrate; a light-emitting device provided on a face opposing the sealing plate in the substrate; a plurality of spacers provided between the substrate and sealing plate so as to be in contact therewith and arranged about the light-emitting device; and a sealant layer, arranged between the substrate and sealing plate so as to bond the substrate and sealing plate to each other, including the light-emitting device and spacers therewithin.

Thus constructed EL panel can restrain the light-emitting area from decreasing in long-term use. Studies by the inventors have elucidated that stresses are likely to concentrate at a contact interface between a sealant covering the light-emitting device and a sealant formed thereabout in the conventional panel (light-emitting apparatus), whereby cracks and peeling are easier to occur in such an interface. External moistures and the like entering from such cracks and the like come into contact with and deteriorate the light-emitting device, thereby reducing the light-emitting area as mentioned above.

In the panel of the present invention, by contrast, the sealant layer is formed so as to include spacers therein, so that stresses are harder to occur in the interface, and end edge parts of the sealant layer are open to the outside, whereby stresses are harder to be kept within the sealant layer and so forth, which seem to make it harder for the above-mentioned cracks and the like to occur. Thus, the panel of the present invention seems to keep the outer air from entering from cracks and the like, and restrain the light-emitting region from decreasing even when used for a long period.

Preferably, in the sealant layer of the panel in accordance with the above-mentioned aspect of the present invention, a region in contact with one of the substrate and sealing plate has an area greater than that of a region in contact with the other. The sealant having such a form bonds the substrate and sealing plate more firmly to each other, thereby improving the durability of the panel and achieving a longer life.

Preferably, the sealant layer is provided so as to fill all the region between the substrate and sealing plate, and cover at least a part of an end edge part of at least one of the substrate and sealing plate. Such a form further improves the bonding strength due to the sealant layer, and thus can further elongate the life of the panel.

Preferably, the sealant layer is made of a cured product of an adhesive composition having a delayed photocurability. The adhesive composition having a delayed photocurability is one which can continuously generate a curing reaction once irradiated with light even when the light irradiation is stopped.

When the panel is used for a display, for example, a color filter is typically provided on the sealing plate side. Such a color filter attenuates light when curing a conventional sealant upon irradiation with the light, thus making it harder to yield a sealant layer in a sufficiently cured state.

When the sealant layer is constructed by a cured product of an adhesive composition having a delayed photocurability as mentioned above, sufficient curing can occur even upon irradiation with the light transmitted through the color filter at the time of curing if thermal curing is used together therewith. As a result, the sealant layer attains a fully favorably cured state, which allows the panel to achieve a durability and a longer life.

More preferably, the spacers are constructed by a resin and a nucleus material dispersed in the resin. Such a structure makes it harder to generate cracks and the like between the sealant layer and spacer, and improves the bonding strength between the substrate and sealing plate.

In another aspect, the present invention provides a panel comprising a substrate; a sealing plate opposing the substrate; a light-emitting device provided on a face opposing the sealing plate in the substrate; and a sealant layer, arranged between the substrate and sealing plate so as to bond the substrate and sealing plate to each other, including the light-emitting device therewithin; wherein, in the sealant layer, a region in contact with one of the substrate and sealing plate has an area greater than that of a region in contact with the other.

Since the sealant layer has such a form in this aspect of the present invention, the substrate and sealing plate seem to be bonded more firmly to each other, whereby the above-mentioned cracks and the like are harder to occur even when stresses are kept within the sealant layer. It seems that the outside air or the like is thus restrained from entering the panel of the present invention from cracks and the like, so that the light-emitting region is less likely to decrease even in long-term use. Also, the sealant layer having the form mentioned above seems to bond the substrate and sealing plate firmly to each other, thereby improving the durability of the panel.

The area of the region in contact with the substrate or sealing plate in the present invention refers to the area of a region surrounded by the outer periphery of a region in contact with the substrate or sealing plate, and is measured by an ultrasonic scanner (FineSAT manufactured by Hitachi Kenki FineTech), for example.

### BRIEF DESCRIPTION OF THE DRAWINGS

FIG. 1 is a view schematically showing a cross-sectional structure of the EL panel in accordance with an embodiment of the present invention;

FIG. 2 is a view showing a planar structure of the EL panel shown in FIG. 1;

FIG. 3 is a view schematically showing a cross-sectional structure of a major portion of an EL device part;

FIG. 4 is a view schematically showing a cross-sectional structure of the EL panel in accordance with another embodiment of the present invention;

FIG. 5 is a view showing a cross-sectional structure of the EL panel in accordance with Comparative Example 1; and

FIG. 6 is a graph comparing results obtained by a light-emitting test of the EL panels in accordance with Example 1 and Comparative Example 1.

### DESCRIPTION OF THE PREFERRED EMBODIMENTS

In the following, preferred embodiments of the present invention will be explained with reference to drawings. Throughout the drawings, constituents identical to each other will be referred to with numerals identical to each other without repeating their overlapping descriptions.

### FIRST EMBODIMENT

First, the structure of the panel in accordance with a preferred embodiment of the present invention will be explained. Here, an EL panel equipped with an organic EL device as a light-emitting device will be explained by way of example.

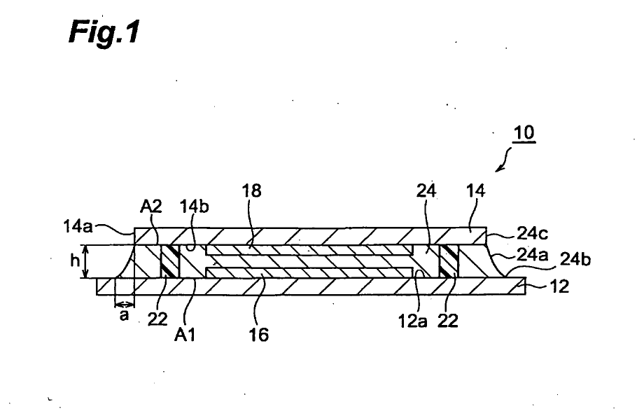

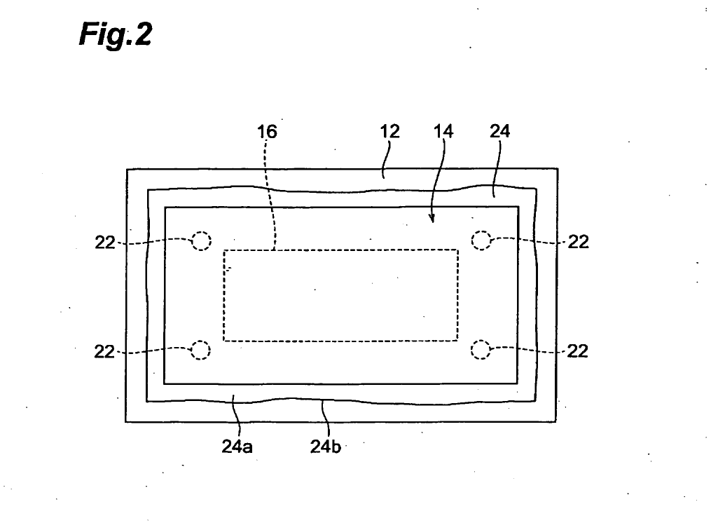

FIG. 1 is a view schematically showing a cross-sectional structure of the EL panel in accordance with the preferred embodiment of the present invention. FIG. 2 is a view showing a planar structure of the EL panel shown in FIG. 1. As depicted, the EL panel 10 has a structure in which a substrate 12 and a sealing plate 14 are bonded to each other via a sealant layer 24. Spacers 22 are arranged between the substrate 12 and sealing plate 14. An El device part 16 is mounted on a face 12a opposing the sealing plate 14 in the substrate 12. A color filter 18 is provided on a face 14b opposing the substrate 12 in the sealing plate 14.

As the substrate 12, those usually used as substrates for EL devices can be employed, examples of which include glass substrates, silicon substrates, film substrates, and organic substrates such as resin substrates.

The sealing plate 14 holds the sealant layer 24 between the substrate 12 and the sealing plate 14. The sealing plate 14 has an area smaller than that of the substrate 12, and opposes a region near the center of the substrate 12 so as to cover the space above the EL device part 16. Preferred as such a sealing plate 14 is one made of a transparent material such as glass in order to take out emissions from the EL device part 16.

The color filter 18 enables the panel to display colors by adjusting emission colors when transmitting the emissions from the EL device part 16 therethrough. As such a color filter 18, those equipped with an RGB cell usually used in liquid crystal panels and the like can favorably be employed. The color filter 18 is not necessary when the EL panel 10 is used for illumination and the like.

The sealant layer 24 fills the region excluding the EL device part 16, color filter 18, and spacers 22 in the space held between the substrate 12 and sealing plate 14. The sealant layer 24 seals the EL device part 16, thereby preventing the EL device part 16 from coming into contact with the outside air (air and moisture). This restrains the EL device part 16 from being deteriorated by moisture and the like.

Between the substrate 12 and sealing plate 14, the sealant layer 24 is formed so as to include the EL device part 16 and spacers 22 therewithin. In the sealant layer 24, the region A1 in contact with the substrate 12 is wider than the area A2 in contact with the sealing plate 14, whereby the widened region A1 protrudes out of the sealing plate 14. In other words, the region A1 has an area greater than that of the region A2. This structure firmly bonds the sealant layer 24 to the substrate 12. The sealing plate 14 is also firmly bonded to the substrate 12 through the sealant layer 24.

Further, the sealant layer 24 has such a form as to turn around to reach an edge end part 14a of the sealing plate 14. Namely, a part (lower part) of the edge end part 14a is covered with the sealant layer 24. Such a structure bonds the sealing plate 14 more firmly to the substrate 12, and can more strongly restrain the outside air from entering between the substrate 12 and sealing plate 14.

The sealant layer 24 is constituted by a cured product of an adhesive composition. The adhesive composition has such a bonding property as to be able to bond the substrate 12 and sealing plate 14 to each other, and such a transparency as to be able to transmit therethrough emissions from the EL device part 16 after being cured. Though any of photo-curing and thermosetting resins may be employed as such a resin material, a photo-curing resin is more preferable, since heating not only makes it easier for the resin material to infiltrate into the EL device part 16, but may deteriorate the EL device part 16.

In particular, an adhesive composition having a delayed photocurability is preferred as the adhesive composition for forming the sealant layer 24. When thermal curing which will be explained later is used together, the adhesive composition having a delayed photocurability sufficiently cures even upon irradiation with light having a low output. Therefore, even when the light is attenuated by the color filter 18 at the time of curing, for example, a sufficient curing reaction occurs.

As the delayed photo-curing adhesive, adhesive compositions of photo-cation-curing (esp., ultraviolet-cation-curing) type are preferred, among which epoxy resins of ultraviolet (UV)-cation-curing type are preferred in particular. An example of such UV-cation-curing epoxy resins is an epoxy resin composition mainly composed of a liquid epoxy resin and a photo-cation polymerization initiator. Specific examples include those in which polymerization initiators containing anions such as SbF₆⁻, AsF₆⁻, PF₆⁻, and BF₄⁻ are mixed with base resins composed of epoxy resins of bisphenol A type and bisphenol F type. Examples of the polymerization initiator include those in which any of the four anions mentioned above and a counterion represented by the following chemical formula (1a) or (1b) or the like form a salt. Among them, trisarylsulfonium hexafluoroantimonate is preferred in particular.

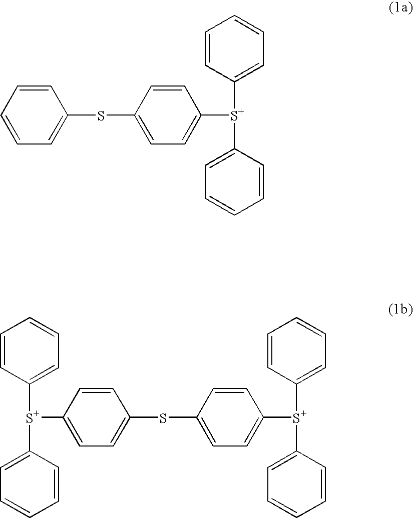

A plurality of (4 here) spacers 22 are arranged about the EL device part 16 so as to surround the EL device part 16. Namely, the spacers 22 are scattered about the EL device part 16. The spacers 22 come into contact with both of the substrate 12 and sealing plate 14 and support them, so as to keep a fixed gap therebetween. Examples of the spacers 22 include glass particles, silica particles, particles made of resins, and metal particles. The spacers 22 are not limited to particulate forms, but may be formed like columns, bands, ellipsoids, and the like.

The spacers 22 are arranged between the substrate 12 and sealing plate 14, while being included within the sealant layer 24. In other words, the sealant layer 24 has such a form as to protrude out of the spacers 22. In such a manner, the sealant layer 24 is in a state where its peripheral parts are open to the outside, and thus has a structure harder to keep stresses therewithin than a conventional structure whose outer peripheral part is surrounded by another sealant.

Preferably, for keeping a fixed gap between the substrate 12 and sealing plate 14, the spacers 22 have such a rigidity as to be undeformable by some pressing. For restraining shifts and the like from occurring between the spacers 22 and the sealant layer 24, however, it will be preferred if the spacers 22 have a favorable affinity to the sealant layer 24. From these viewpoints, it will be preferred if the spacers 22 have a structure in which a rigid nucleus material (e.g., metal particle) is dispersed in a flexible material (e.g., resin).

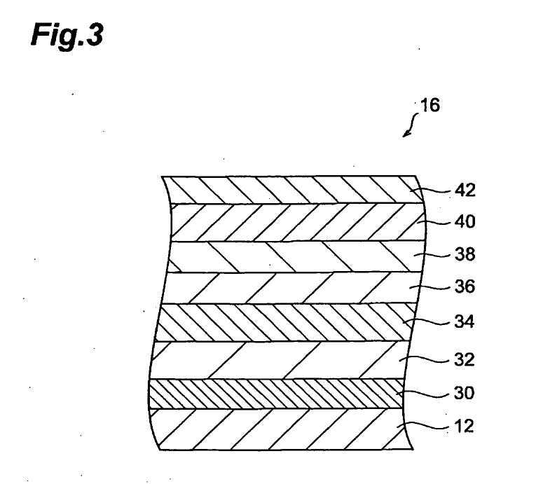

As mentioned above, the EL device part 16 is provided on the substrate 12, and is in a state sealed with the sealant layer 24 filling the space between the substrate 12 and sealing plate 14. The structure of the EL device part 16 mounted in the EL panel 10 will now be explained with reference to FIG. 3. FIG. 3 is a view schematically showing a cross-sectional structure of a major portion of the EL device part. Here, a case where an organic EL device is formed as the EL device part 16 will be explained by way of example.

The EL device part 16 is one in which an anode 30, a hole injection layer 32, a hole transport layer 34, an emission layer 36, an electron transport layer 38, an electron injection layer 40, and a cathode 42 are successively formed on the substrate 12. The EL device part 16 is an organic EL device of so-called top emission type which takes emissions out of the emission layer 36 from the end face opposite from the substrate 12.

In the EL device part 16, the anode 30 may be a transparent electrode such as ITO (Indium Tin Oxide) or a reflective electrode such as metal, whereas the reflective electrode is preferred from the viewpoint of efficiently taking out light. On the other hand, the cathode 42 is a transparent electrode such as ITO in order to take out light from the emission layer 36.

As the hole injection layer 32, hole transport layer 34, electron transport layer 38, and electron injection layer 40, those made of known materials used for these purposes in the organic EL device can be employed. The emission layer 36 is made of any of low- and high-molecular light-emitting materials. The emission layer 36 may be doped with desirable organic materials and the like.

The organic EL panel 10 is not limited to the mode in which light is taken out from the sealing plate 14 side as mentioned above. For example, the substrate 12 may be constructed by a transparent material, so as to take out light from the substrate 12 side. In the latter case, the EL device part 16 constitutes a so-called bottom emission type organic EL device. In this case, the color filter 18 is not required to be provided on the sealing plate 14 side, but is preferably arranged at a given position on the substrate side.

A method of manufacturing thus constructed EL panel 10 will now be explained.

First, in the method of manufacturing the EL panel 10, a substrate 12 is prepared, and layers constituting the above-mentioned EL device part 16 are laminated on the substrate 12. The layers can be formed by given methods. For example, vapor deposition can be used for forming layers made of inorganic materials or low-molecular organic materials, whereas known coating and printing methods can be employed for forming layers made of high-molecular organic materials.

Next, a plurality of particulate spacers 22 are scattered about the EL device part 16. Here, it will be sufficient if the spacers 22 are formed, for example, by the steps of applying a resin composition containing a nucleus material and a resin to the surroundings of the EL device part 16 and then curing the resin composition. The resin composition can be applied by screen printing or with a dispenser, for example.

Subsequently, a sealant which will constitute a sealant layer 24 after curing is dropped onto the inside of the spacers 22. A resin material capable of constructing the sealant layer 24, preferably an adhesive composition having a delayed photocurability, can be used as the sealant. The sealant may contain additives, e.g., filler, other than the resin material.

When the spacers 22 are formed from a resin composition containing a nucleus material and a resin, the resin in the resin composition preferably has a viscosity higher than that of the sealant. In this case, the resin is harder to flow than the sealant when the resin composition is applied to the surroundings of the EL device part 16, whereby the resin can firmly attach the nucleus material to the surface 12a of the substrate 12. This sufficiently prevents the spacers 22 from shifting from their predetermined positions. As a result, a uniform gap can be attained between the sealing plate 14 and substrate 12, whereby distortions due to stresses, microscopic cracks, and peeling can fully be prevented from occurring, and the light-emitting region can more fully be kept from decreasing. Here, the resin is not restricted in particular as long as it can firmly attach the nucleus material to the substrate 12 or sealing plate 14 while having a viscosity higher than that of the sealant. Examples of such a resin include polyamide and acrylate.

The amount of the sealant is such that at least the EL device part 16 and spacer 22 are contained therein after the sealing plate 14 is bonded as will be explained later. In a preferred case, the space between the substrate 12 and sealing plate 14 is filled with the sealant layer 24, while its peripheral part protrudes out of the substrate 12 or sealing plate 14.

In the manufacture of the EL panel 10, while forming a structure including the substrate 12, EL device part 16, spacers 22, and sealant, the sealing plate 14 provided with a color filter 18 is prepared. An example of method of forming the sealing plate 14 with the color filter 18 is a technique in which respective color filters of R, G, and B are successively formed on the sealing plate 14 by photolithography or the like.

Next, the above-mentioned structure and the sealing plate 14 provided with the color filter 18 are bonded together, so as to yield a panel precursor. In the process of bonding, the sealing plate 14 is initially arranged with respect to the above mentioned structure such that the EL device part 16 and color filter 18 oppose each other. Subsequently, the substrate 12 and sealing plate 14 are pressed from the outside thereof. Here, heating may be effected together with pressing.

When the spacers 22 are constructed by the nucleus material and resin as mentioned above, the resin is crushed by pressing, whereas the gap between the substrate 12 and sealing plate 14 is favorably kept by the nucleus material having a higher rigidity. As a result, the spacers 22 are closely attached to the sealant, substrate 12, sealing plate 14, and the like by the resin and thus are harder to generate shifts and the like in the EL panel 10.

Thereafter, the sealant held between the substrate 12 and sealing plate 14 is cured, so as to form the sealant layer 24, thereby bonding the substrate 12 and sealing plate 14 to each other, thus yielding the EL panel 10 having the structure shown in FIG. 1. The sealant is cured by appropriately selecting means such as photo-curing or thermal curing according to the resin material constituting the sealant. When an adhesive composition having a delayed photocurability as mentioned above (hereinafter referred to as “delayed photo-curing composition”) is used as the sealant, the following two-step curing is preferably performed instead of curing at once upon irradiation with light.

First, the delayed photo-curing composition as the sealant is irradiated with light, so as to start a polymerization reaction of the composition, thereby effecting partial curing. Here, the partial curing refers to a state where the curing composition is not completely cured but keeps flowability to a certain extent. The extent of curing in the curing composition can be determined by a differential scanning calorimeter (DSC), for example. In the first curing step, it will be preferred if the sealant is cured to such an extent as to keep a rubber state.

The light used for curing is not limited in particular as long as it can cure the delayed photo-curing composition. When the composition is one which cures upon irradiation with ultraviolet rays, for example, the ultraviolet rays are used. An example of the ultraviolet rays is light emitted from a high-pressure mercury lamp.

The partial curing of the delayed photo-curing composition can be effected when conditions concerning the amount of irradiation, irradiation time, and the like of light with respect to the sealant are set such that the delayed photo-curing composition is not completely cured. Specific examples include a method in which light emitted from a light source typically used for curing a photo-curing resin is attenuated through a filter or the like and then illuminates the sealant, and a method in which light from such a light source is emitted for a time shorter than the conventional one. When a light source which can adjust the output of light is used, it will be sufficient if light whose output has been adjusted so as to become suitable for the partial curing is emitted therefrom.

When the panel precursor has the transparent sealing plate 14 equipped with the color filter 18 as in this embodiment, arranging the conventional light source on the sealing plate 14 side allows the color filter 18 to attenuate the light emitted from the light source, whereby the sealant is irradiated with the light suitable for the partial curing as mentioned above.

Next, when curing the delayed photo-curing composition, the sealant irradiated with light is heated, Consequently, the partly cured delayed photo-curing composition further advances its polymerization reaction, whereby the composition cures substantially completely. Thus, the sealant layer 24 is formed. In the process of heating, the light irradiation may be either continued or stopped.

In this process, the polymerization reaction generated in the curable adhesive composition by the light irradiation is further advanced by heating. When a UV-cation-curing epoxy resin is used as a curable adhesive composition, for example, a cationic polymerization initiated by the light irradiation proceeds like a chain reaction by heating, whereby the UV-cation-curing epoxy resin cures substantially completely.

In the EL panel 10 constructed as mentioned above, the sealant layer 24 has a structure containing therein not only the EL device part 16 but also the spacers 22. Conventionally, a sealant filling the inside of a panel has been surrounded by another sealant from the outside, so that stresses are likely to concentrate between the inner and outer sealants, and stresses generated in the inner sealant at the time of manufacture are likely to be held therein. Therefore, cracks and peeling tend to occur in conventional panels because of the above-mentioned stresses, so that light-emitting devices are gradually deteriorated by the outside air (moisture or the like) entering from the cracks and the like.

In this embodiment, by contrast, the contact area between the sealant layer 24 and spacers 22 is so small that the above-mentioned concentration of stresses is hard to occur, whereby cracks, peeling, and the like are greatly restrained from occurring between them. As a result, the EL device part 16 sealed within the sealant layer 24 rarely comes into contact with the outside air through cracks and the like, and is hard to be formed with a nonluminous region (dark spot) even when used for a long term.

Stresses in the sealant layer 24 become smaller in particular when the sealant layer 24 is made of a cured product of an adhesive composition having a delayed photocurability as mentioned above. Such a structure makes it harder to generate cracks and the like in the EL panel 10, whereby the EL panel 10 can achieve a longer life.

### SECOND EMBODIMENT

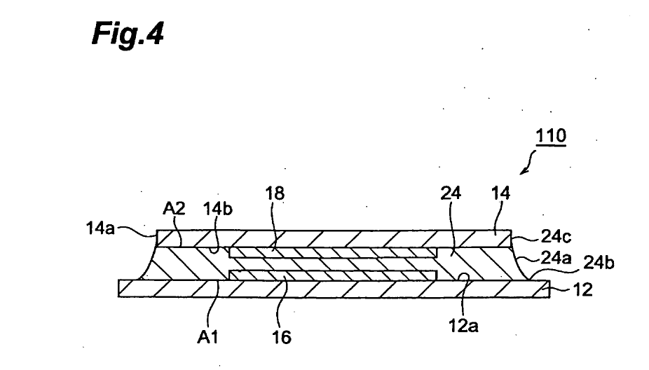

A second embodiment of the panel in accordance with the present invention will now be explained with reference to FIG. 4.

FIG. 4 is a view schematically showing a cross-sectional structure of the EL panel in accordance with the second embodiment of the present invention. As shown in FIG. 4, the panel 110 in accordance with this embodiment differs from the panel 10 in accordance with the first embodiment in that it lacks the spacers 22.

In the sealant layer 24 in the panel 110, the region A1 in contact with the substrate 12 is wider than the region A2 in contact with the sealing plate 14, whereby the widened region A1 protrudes out of the seating plate 14. In other words, the region A1 has an area greater than that of the region A2.

It seems that, since the sealant layer 24 has the form mentioned above, the substrate 12 and sealant layer 14 are firmly bonded to each other, whereby cracks and the like are hard to occur within the sealant layer 24 even when stresses are held within the sealant layer 24. Consequently, in the EL panel 110, the outside air is restrained from entering from cracks and the like, so that the light-emitting region is less likely to decrease even in long-term use. Also, since the sealant layer 24 has the form mentioned above, the substrate 12 and sealing plate 14 are firmly bonded to each other, whereby the durability of the panel 110 improves.

In the EL panel 110 in accordance with this embodiment, assuming that the ratio R is represented by the following expression:
R=100×(A1-A2)/A2
where A1 is the contact area between the substrate 12 and sealant layer 24, and A2 is the contact area between the sealing plate 14 and sealant layer 24, R is preferably at least 0.020001% (=200 ppm). When R is smaller than this value, cracks will be easier to occur if a stress is held in the sealant layer 24. The ratio R is preferably 400% or less in order to attain a longer life.

Assuming that the ratio P is represented by the following expression:
P=a/h×100
where h is the thickness of the sealant layer 24, and a is the spread of the skirt of the sealant layer 24, it will further be preferred if P is at least 10%. Here, the spread a of the skirt of the sealant layer 24 refers to the width between the outer periphery of the projection of the contact area between the sealing plate 14 and sealant layer 24 onto the surface 12a of the substrate 12 and the outer periphery of the contact area between the substrate 12 and sealant layer 24. When P is less than 10%, cracks will be easier to occur if a stress is held in the sealant layer 24. The ratio P is preferably 50,000% or less in order to attain a longer life.

The present invention is not limited to the panel having the above-mentioned structure, but can be modified as appropriate within the scope not deviating from its gist. For example, the EL device part in the present invention is not limited to the above-mentioned top emission type, but may be a bottom emission type EL device in which emissions are taken out from the substrate side. In this case, color filters and passivation films may be formed between the substrate and EL device part. The panel is not limited to the above-mentioned EL panel mounted with the organic EL device. The present invention can be employed without any restrictions at all in any panels including light-emitting devices with similar sealing structures such as EL panels mounted with inorganic EL devices.

Though the sealant layer 24 has such a form as to turn around to reach the edge end part 14a of the sealing plate 14 in the first and second embodiments, the sealant layer 24 is not required to do so but may have such a form that the face 14b of the sealing plate 14 and the outer peripheral face 24a of the sealant layer 24 intersect. Namely, it will be sufficient if the region A2 has an area smaller than that of the face 14b of the sealing plate 14.

Though the area A1 in contact with the substrate 12 is wider than the area A2 in contact with the sealing plate 14 in the sealant layer 24 in the first embodiment, so that thus widened region A1 protrudes out of the sealing plate 14, the area of the region A1 may be either equal to or smaller than the area of the region A2.

Though the area A1 in contact with the substrate 12 is wider than the area A2 in contact with the sealing plate 14 in the sealant layer 24 in the second embodiment, so that thus widened region A1 protrudes out of the sealing plate 14, the area of the region A1 may be smaller than the area of the region A2. In short, it will be sufficient if the area of the region A1 is not equal to the area of the region A2.

### EXAMPLES

In the following, the present invention will be explained in further detail with reference to examples. However, the present invention is not limited to these examples.

Manufacture of EL Panel

### Example 1

First, an organic EL device having an EL device part provided on a substrate was formed. Next, spacers made of a resin containing a nucleus material constituted by glass beads for forming a gap between the substrate and a sealing plate were formed at four positions on the substrate surface. The spacers were obtained by the steps of mixing the nucleus material into a UV-cation-curing epoxy resin (XNR5570 manufactured by Nagase ChemteX Corporation), so as to prepare a resin composition; applying the resin composition with a dispenser to the surroundings of the EL device part at four positions on the surface of the substrate; and curing the resin composition upon irradiation with UV rays.

Then, as a sealant, the same UV-cation-curing epoxy resin (XNR5570 manufactured by Nagase ChemteX Corporation) as that mentioned above was dropped onto the region surrounded by the spacers. Subsequently, a transparent sealing plate was arranged so as to oppose the EL device part, and they were bonded together under pressure, so as to yield a panel precursor. All the spacers were contained within the sealant in the panel precursor.

Thus obtained panel precursor was irradiated from the sealing plate side with UV rays (with an output of 13,000 mJ/cm²) emitted from a high-pressure mercury lamp, so as to cure the UV-cation-curing epoxy resin as the sealant, thereby forming a sealant layer and thus yielding an EL panel having the same structure as that shown in FIG. 1 except for the lack of the color filter. When thus obtained EL panel was observed, it was verified that cracks, peeling, and the like were not generated within the panel.

### Comparative Example 1

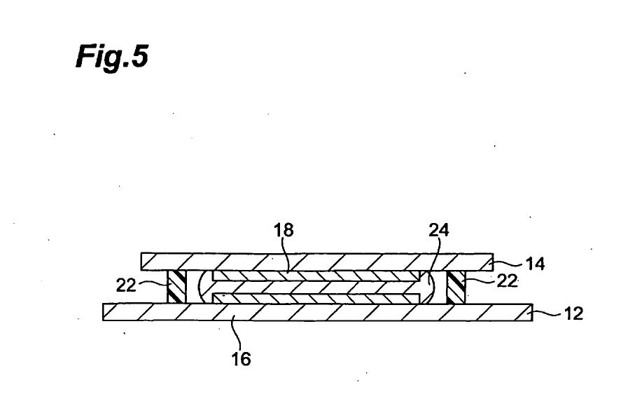

An EL panel having the cross-sectional structure shown in FIG. 5 was obtained as in Example 1 except that the UV-cation-curing epoxy resin as the sealant was dropped such that the sealant layer was formed only on the inside of the spacers. When thus obtained EL panel was observed, slight cracks were seen within the panel.

### Example 2

An EL panel was manufactured as in Example 1 except that spacers were formed as follows. Namely, the spacers were obtained by the steps of mixing the nucleus material into a UV-curing acrylate adhesive having a viscosity higher than that of the UV-cation-curing epoxy resin (XNR5570 manufactured by Nagase ChemteX Corporation), so as to prepare a resin composition; applying the resin composition with a dispenser to the surroundings of the EL device part at four positions on the surface of the substrate; and curing the resin composition upon irradiation with UV rays.

When thus obtained EL panel was observed, it was verified that cracks, peeling, and the like were not generated within the panel.

### Example 3

An EL panel was obtained as in Example 1 except that no spacers were formed about the EL device part.

Specifically, an organic EL device having an EL device part provided on a substrate was initially formed. Subsequently, as a sealant, a UV-cation-curing epoxy resin (XNR5570 manufactured by Nagase ChemteX Corporation) was dropped onto the substrate. Then, a transparent sealing plate was arranged so as to oppose the EL device part, and they were bonded together under pressure, so as to yield a panel precursor.

Thus obtained panel precursor was irradiated from the sealing plate side with UV rays (with an output of 13,000 mJ/cm²) emitted from a high-pressure mercury lamp, so as to cure the UV-cation-curing epoxy resin as the sealant, thereby forming a sealant layer and thus yielding an EL panel having the same structure as that shown in FIG. 1 except for the lack of the color filter.

Using an ultrasonic scanner (FineSAT manufactured by Hitachi Kenki FineTech), the interface between the substrate and sealant layer and the interface between the sealant layer and sealing plate were observed. Using thus obtained images of the interfaces, the contact area between the substrate and sealant layer and the contact area between the sealant layer and sealing plate were calculated. As a result, R=(A1-A2)/A2=about 1,000 ppm, which indicated that the contact area between the substrate and sealant layer was greater than the contact area between the sealant layer and sealing plate.

When thus obtained EL panel was observed, it was verified that cracks, peeling, and the like were not generated within the panel.

### Comparative Example 2

An EL panel was manufactured as in Example 3 except that the UV-cation-curing epoxy resin as the sealant was dropped such that the sealant layer did not protrude from between the sealing plate and substrate.

The contact area between the substrate and sealant layer and the contact area between the sealant layer and sealing plate were calculated in thus obtained EL panel as in Example 3. As a result, R=(A1-A2)/A2=about 30 ppm, which indicated that the contact area between the substrate and sealant layer was substantially equal to the contact area between the sealant layer and sealing plate.

When thus obtained EL panel was observed, slight cracks were seen within the panel.

### Emission Test

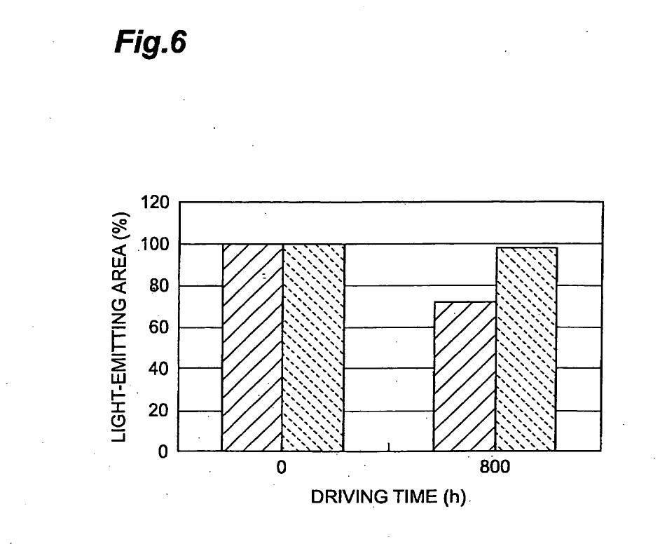

Using thus obtained EL panels of Examples 1 to 3 and Comparative Examples 1 and 2, an emission test for determining decreases in their light-emitting regions after a long time of emission was performed. First, each EL panel was caused to emit light immediately after the manufacture, and the area of its light-emitting region was measured. The emission was continued, and the area of the light-emitting region was measured again after the lapse of 800 hours. Then, assuming that the area of the light-emitting region immediately after the manufacture was 100, the area of the light-emitting region after the long time of emission was calculated. Thus obtained results are shown in Table 1 and FIG. 6. FIG. 6 is a graph comparing the results of the EL panels of Example 1 and Comparative Example 1 obtained by the emission test. In FIG. 6, the right and left bars in each pair refer to the results of Example 1 and Comparative Example 1, respectively.

TABLE 1

Light-emitting area (ratio)

| | Immediately after | After 800 hr of |
|---|---|---|
| | manufacture | emission |
| Example 1 | 100 | 98 |
| Example 2 | 100 | 97 |
| Example 3 | 100 | 97 |
| Comparative Example 1 | 100 | 72 |
| Comparative Example 2 | 100 | 75 |

Table 1 and FIG. 6 verified that, as compared with the EL panel of Comparative Example 1 in which the sealant layer was formed on the inside of the spacers such that the spacers were not included in the sealant layer, the EL panel of Example 1 exhibited a much smaller decrease in the light-emitting region even after 800 hours of emission and thus could realize a longer life.

Table 1 also verified that, as compared with the EL panel of Comparative Example 1 in which the sealant layer was formed while the spacers were not included in the sealant layer, the EL panel of Example 2 having the sealant layer formed so as to include the spacers therewithin exhibited a much smaller decrease in the light-emitting region even after 800 hours of emission and thus could realize a longer life.

Table 1 further indicated that, as compared with the EL panel of Comparative Example 2, the EL panel of Example 3 exhibited a much smaller decrease in the light-emitting region even after 800 hours of emission and thus could realize a longer life. This has verified that an EL panel in which the area of the region in contact with one of a substrate and a sealing plate is greater than the area of the region in contact with the other can fully prevent the light-emitting area from decreasing even when no spacers are interposed between the substrate and sealing plate.

As explained in the foregoing, the present invention can provide a panel which can sufficiently keep a light-emitting area even when used for a long period.

What is claimed is:

1. A panel comprising:
a substrate;
a sealing plate opposing the substrate;
a light-emitting device provided on a face opposing the sealing plate in the substrate;
a plurality of spacers provided between the substrate and sealing plate so as to be in contact therewith and arranged about the light-emitting device; and
a sealant layer, arranged between the substrate and sealing plate so as to bond the substrate and sealing plate to each other, including the light-emitting device and spacers therewithin.

2. A panel according to claim 1, wherein a region in contact with one of the substrate and sealing plate has an area greater than that of a region in contact with the other.

3. A panel according to claim 1, wherein the sealant layer covers at least a part of an end edge part of at least one of the substrate and sealing plate.

4. A panel according to claim 1, wherein the sealant layer is made of a cured product of an adhesive composition having a delayed photocurability.

5. A panel according to claim 1, wherein the spacers are constructed by a resin and a nucleus material dispersed in the resin.

6. A panel comprising:
a substrate;
a sealing plate opposing the substrate;
a light-emitting device provided on a face opposing the sealing plate in the substrate; and
a sealant layer, arranged between the substrate and sealing plate so as to bond the substrate and sealing plate to each other, including the light-emitting device therewithin;
wherein, in the sealant layer, a region in contact with one of the substrate and sealing plate has an area greater than that of a region in contact with the other.
